(19) United States
(12) Patent Application Publication
(10) Pub. No.: US 2010/0313074 A1
(43) Pub. Date: Dec. 9, 2010

(54) METHOD FOR DESCRIBING A BEHAVIOR OF A TECHNICAL APPARATUS

(75) Inventors: Nghia Dang Duc, Hildesheim (DE); Peter Engel, Hildesheim (DE); Gerrit De Boer, Hildesheim (DE); Sascha Goldner, Ingotstadt (DE)

Correspondence Address: MERCHANT & GOULD PC, P.O. BOX 2903, MINNEAPOLIS, MN, 55402-0903, US

(73) Assignee: Robert Bosch Gmbh

(21) Appl. No.: 12/681,134

(22) PCT Filed: Sep. 30, 2008
(86) PCT No.: PCT/EP2008/063096

§ 371 Date: Aug. 23, 2010

(30) Foreign Application Priority Data
Oct. 4, 2007 (DE) 102007047421.2

(51) Int. Cl. G06F 11/07

(52) U.S. Cl. 714/37; 714/E11.029

(57) ABSTRACT

The invention relates to a method for describing a behavior of a technical apparatus, which has a number of units, a system graph (8), which comprises a number of levels, being automatically generated for the technical apparatus, in each case a k+1th level being subordinate to a kth level and at least one subordinate unit in the k+1th level being associated with a superior unit from the kth level, a technical behavior of the at least one subordinate unit being summarized in each superior unit. Furthermore, the invention relates to a method for the diagnosis of a technical apparatus.

The invention relates to a method for describing a behavior of a technical apparatus, a method for the diagnosis of a technical apparatus, a device for describing a behavior of a technical apparatus, a computer program and a computer program product.

### TECHNICAL FIELD

In modern motor vehicles, functionalities are increasingly provided by means of software. A spectrum of these functionalities encompasses the engine control to the comfort system. A computer architecture lying at the basis of said software is configured as a distributed system. Depending on the model of motor vehicle, 20 to 80 control unit nodes exist in said vehicle. These control unit nodes are connected to four different bus systems, wherein a program code can comprise several hundred thousand to several million lines. It can be expected that this degree of cross-linking in the motor vehicle will constantly increase in the coming years. Moreover, the increasing complexity of hydraulic, pneumatic and mechanical motor vehicle components as well as the increasing variety of models of motor vehicles will be additional factors.

For these reasons, the trouble shooting and fixing of problems is substantially more difficult in the automotive repair shop. When an auto is serviced in the shop, the standard diagnostic strategy is typically of a symptomatic nature, i.e. a starting point for the diagnosis in the shop is a certain amount of symptoms of a malfunction, which usually can come from three sources of diagnostic information, which are mentioned below:
items of information which emanate from control unit diagnoses and are provided during a so-called online diagnosis,
items of information from physically measured variables, for example voltage, pressure, exhaust gases etc., which are ascertained during an offline diagnosis, and
items of information from subjective observations by the service technicians, for example on the basis of noises or a visual inspection.

Different diagnostic tools exist today, which support the service personal in the shop when trouble shooting problems. Advanced systems are based on algorithms for model-based diagnoses. These algorithms analyze all available items of diagnostic information and compare and contrast them with a functional model for the motor vehicle. The behavior of the motor vehicle is reflected to a certain degree of detail by the functional model. The models are hierarchically structured as a rule, i.e. there are models of components, which in their circuitry depict the model of a subsystem. Consequently a plurality of subsystem models form models of systems, such as, for example, brake and engine systems etc. The bulk of all system models finally forms the model of the motor vehicle.

### SUMMARY

The method according to the invention is suited for describing a behavior of a technical apparatus. This apparatus has a number of units. In the method, a system graph, which comprises a number of levels, is automatically generated for the technical apparatus, in each case a k+1th level being subordinate to a kth level and at least one subordinate unit in the k+1th level being associated with a superior unit from the kth level, a technical behavior of the at least one subordinate unit being summarized in each superior unit.

A description, respectively a model, of the technical apparatus and in particular of a functional behavior of this apparatus is therefore provided by means of the system graph which is automatically generated, respectively modeled, within the scope of the method. The system graph can have a tree-like structure, wherein each unit within the system graph is associated with a node so that a superior node of the kth level has at least one branch to at least one subordinate node of the k+1th level. The result thereby is among other things that a unit is represented in each case by a node within the system graph.

The behavior of the superior unit, which is associated with this superior node, as well as the behavior of the at least one subordinate unit of the k+1th level, which is associated with the superior unit, is described in its configuration via the superior node of the kth level.

A behavior to be expected can therefore typically be deposited for each unit at each node within the system graph.

The invention relates further to a method for the diagnosis of a technical apparatus, which has a number of units, a behavior of this technical apparatus being described by a method according to the invention, which was previously described, wherein
when trouble shooting at least one fault, initially a kth level of the system graph is examined for a faulty unit of the technical apparatus and wherein
when the trouble shooting is continued in a k+1th level of the system graph, only that at least one subordinate unit is examined, which is associated with the unit of the kth level that is identified as faulty.

In so doing, provision is made among other things for a faultless behavior, respectively nominal behavior, to be deposited within the system graph for each unit at the associated node. Within the scope of the diagnosis, this faultless, respectively correct, behavior is compared with a real behavior, respectively actual behavior. In the case of a possible deviation of the real behavior from the faultless behavior, if need be while taking into account a tolerance range, a unit can be identified as faulty or faultless. As a result, a single, simple fault can be sought and found. It is, however, also possible to trouble shoot and find a plurality of faults or a multiple fault. Such multiple faults can also be present in a subsystem so that the levels under it are successively analyzed.

In addition each unit within a system graph can be associated with a node and can consequently be represented by such a node, these nodes according to a structure of the system graph being connected to each other via branches so that only branches with nodes, with which faulty units are associated, have to be analyzed for trouble shooting at least the one fault. An analysis of branches and pathways emanating from the same, which are identified as faultless, is not necessary. The trouble shooting for at least one fault is accordingly simplified by virtue of the fact that the technical behavior of all of the subordinate nodes, respectively units of the k+1th level and consequently also additional subordinate levels, for example the k+2th level etc., is summarized in a superior node, respectively in a superior unit of the kth level.

The invention furthermore relates to a device, which is configured for the purpose of describing a behavior of a technical apparatus, which has a number of units, and in this regard to automatically generate a system graph, which comprises a number of levels, for the technical apparatus. In so doing, a k+1th level is in each case subordinate to a kth level and at least one subordinate unit in the k+1th level is associated with a superior unit from the kth level, a technical behavior of the at least one subordinate unit being summarized in each superior unit.

This device is designed in its configuration for the purpose of trouble shooting a fault within the technical apparatus and in this regard to initially examine the kth level within the technical apparatus for a faulty unit. When the troubleshooting is continued in the k+1th level, only that at least one subordinate unit is examined, which is associated with a unit in the kth level that is identified as faulty.

This device according to the invention is configured for the purpose of executing all of the steps of at least one of the previously described methods, i.e. of the method for describing a behavior of the technical apparatus and/or of a method for the diagnosis of the technical apparatus. The trouble shooting for the fault within the scope of the diagnosis of the technical apparatus occurs by means of the system graph, which is automatically generated and consequently modeled.

The computer program according to the invention with program code means is configured for the purpose of carrying out all of the steps of a presented method if the computer program is executed on a computer or in a corresponding processing unit, in particular in a device according to the invention.

The invention also relates to a computer program product with program code means, which are stored on a machine-readable data carrier, which is configured to carry out all of the steps of a described method if the computer program is executed on a computer or in a corresponding processing unit, in particular in a device according to the invention.

In a variation of the invention, the technical apparatus, for example a motor vehicle, can comprise a plurality of systems, wherein at least one subsystem as one unit is associated in each case with a system as one unit, and at least a functional component as one unit is associated in each case with at least one subsystem. The method is, however, not limited to one level with subsystems. Additional units, respectively subsystems of a lower lying level can be subordinate to and hence associated with superior subsystems, respectively units of one level. In one embodiment of the invention, the aforementioned systems are accordingly associated with units and hence nodes of a first level (k=1). The subsystems are associated with units, respectively nodes, of at least one second level (k+m=1+m). Subsystems of a lower lying level etc. are thus, for example, associated with subsystems of an uppermost second level, respectively of a level for subsystems. The components of the subsystems, in particular subsystems of a lowermost second level, respectively level for subsystems, are furthermore associated with units and hence nodes of a third level (k+m+2).

The system graph for the technical apparatus can as a rule have an arbitrary number of levels. In the first, upper level, at least one system is associated with at least one unit, respectively with at least one node. The second level lying under it is provided for the subsystems. In so doing, additional subsystems, the nodes and therefore the units of an additional level are, respectively can be, associated with subsystems of one of these levels. In this way, the system graph can definitely have a plurality of levels for subsystems, respectively intermediate levels. The number of the levels for subsystems depends on the construction of the technical apparatus so that any number of subsystems can be produced as an embodiment.

Within such a system graph, the systems of the first level are connected via branches to subsystems of the second level, which are associated with systems of the first level. In addition the components of the third level are connected to subsystems of the second level via branches, which emanate from said subsystems, and are consequently subordinate to, respectively associated with, these subsystems of the second level. Furthermore, a component of the third level is in each case connected to a system of the first level via a subsystem of the second level within the system graph and is consequently associated with, respectively subordinate to, this system of the first level.

During a diagnosis and therefore when trouble shooting the technical apparatus, only the nodes and hence the systems of the first level are analyzed in a first step. Provision is made in a second step to analyze the subsystems and hence the nodes of the second level. In so doing, a descent into the second level only occurs beginning with nodes, respectively systems, which were identified as faulty within the first step. After an analysis of the subsystems, respectively nodes, of the second level, an analysis of the nodes, respectively components, of the third level occurs in a third step. Such an analysis occurs only for components, which are associated with a subsystem identified as faulty.

Provision is made within the scope of the invention for a behavior of the subsystems and hence of the units of the second level and furthermore a behavior of the components and hence of the units of the third level to be summarized in each case in a system and therefore in each case in a unit of the first level.

An association of the individual units of the technical apparatus, which have been mentioned, and hence also a summary of the behavior of subordinate units are collectively depicted via branches. In the event that a component in the third level should be faulty according to this, a fault in this component is also reflected in the subsystem of the second level and in the system of the first level. When trouble shooting a fault, which, for example, is hidden in a component, said fault is to be sought along a pathway, which comprises branches and which connects the component to the superior subsystem as well as to the superior system further on in said pathway. A total behavior of all of the associated nodes is thus summarized along such a pathway. As a result, trouble shooting a fault merely involves following a pathway, which bears a fault.

A summary or accumulation, respectively aggregation, of a total behavior of the child nodes, which are subordinate to or associated with this node, of at least one lower level occurs at each node in the configuration. A level based diagnosis of the behavior of the technical apparatus is therefore possible.

The method is overall suited for describing the functional behavior for motor vehicles. The device according to the invention for providing the description of the technical apparatus as well as for the diagnosis of this technical apparatus can have a processing unit, respectively a computer, which interacts with analyzers, which are connected to the technical apparatus. The computer program according to the invention can be employed in the device according to the invention for providing the description.

An optimized diagnosis of a system is possible among other things with this invention. A determination can thereby be made already in the system level, respectively first level, whether a fault is present in the system being examined. A descent into the subsystem level, respectively second level, as well as into the component level, respectively third level, occurs only when a fault is present. A method among other things is therefore described, with which an unnecessary descent in a pathway, respectively diagnostic branch, can be avoided.

The subdivision of levels within the system graph with the aid of the previously described example merely depicts a possible example. Provision can be made for more than only three levels and hence also for intermediate levels. It is therefore, for example, possible that any number of subsystem levels can be present, which are superior to, respectively subordinate to, each other and as a rule are provided for subsystems. Provision can also furthermore be made for a mixture of levels to exist, wherein subsystems as well as components can exist within a level. In the event that provision is made, for example, for a subsystem to be in a superior level lying above it, a component as well as an additional subsystem is then subordinate to said subsystem in the level lying under it.

Faster diagnoses can consequently be carried out in particular in systems with many subsystems as well as components. In so doing, it is initially sufficient to examine the uppermost level, as a rule the first level, of a system hierarchy. If no fault is present, the diagnosis is finished. Otherwise a descent into the next lower level has to occur. A generation of a behavior description for the systems, respectively subsystems, arranged in the levels can thereby take place in a modeling program or tester when the diagnosis is inputted. A diagnosis is also possible when the modeling is incomplete. A minimum requirement is a modeling of the behavior on the first, uppermost level, namely the system level. As was already mentioned, systems, whose behavior is correct, can already thereby be prematurely excluded from the intensive diagnosis. In so doing, it is usually of no interest to what extent the subsystems are developed or not.

When implementing the invention, provision is made for a determination to be made at each node of the system graph whether a fault is present at this location. For this purpose, the expected behavior is deposited at each node, respectively at each unit, of a level, which, for example, can occur in the form of equations or behavior tables. Because a system typically consists of one or a plurality of subsystems and the behavior can be deposited at each node, a node summarizes in each case the total behavior of its subordinate nodes, respectively child nodes. If the expected correct behavior correlates with the actual behavior, a descent into the underlying level does not have to occur for further diagnosis. A descent into the underlying level typically occurs if the behavior of the subordinate nodes should be faulty.

A method for the diagnosis can be carried out in its configuration based on levels, i.e. initially all of the nodes are examined before a descent into the underlying level results. When examining the nodes of a level, all nodes whose behavior is presumably incorrect are declared to be suspicious. The descent into the subordinate level lying underneath it then only results beginning with the suspicious nodes. The procedural approach is identical in said underlying level. All of the nodes of this level are initially examined before a further descent into the next underlying level results. This process can be implemented up until achieving the lowest level and until all faulty subsystems and furthermore all faulty components are identified.

The models are typically on hand in a modeling language. In so doing, a modeled unit generally has inlets and outlets, wherein a relation between the inlets and the outlets is described by means of relationships, for example behavior tables or equations, with the aid of the modeling language. The relationships in a model contain parameters as a rule, which can likewise be adjusted within the scope of the modeling. When interconnecting partial models, for example components or subsystems, the perception of the so-called materials has established itself. These materials are transported between and also through components and therefore units, respectively nodes, of the levels. Materials have attributes, which can be changed during transport through a component or through a subsystem. In one example, provision is then made for air to be the material. The attributes in this instance are temperature, pressure, humidity or similar parameters. An interconnection of the partial systems and the modeling of materials likewise occur with the aid of the modeling language.

It is therefore possible in an additional configuration for an analysis of the units, respectively nodes, which are to be examined within the scope of the diagnosis, to be carried out while taking into account the materials, in particular an operating medium such as air, water, fuel and/or a lubricant, and the attributes associated with such materials, respectively physical parameters of these materials like air, pressure, temperature, etc.

Among other things, problems, which arise during the generation of the models and hence during modeling, can be solved using the invention. The way in which the modeling is done decides to a great extent how effective the diagnosis will later be. A level of abstraction of the model is selected in such a way that the diagnostic algorithms can find the defective components. A more precise modeling would be additionally advantageous but would increase its complexity and reduce the reusability of the models. Therefore, the extreme case, i.e. an exact, detailed functional model of a custom motor vehicle whose modeling components would not be reusable, is, for example, possibly not very useful because the modeling complexity would be very great while its use would be restricted to a single motor vehicle model. For this reason, elements for object-oriented modeling can also be used in the configuration. In so doing, universally valid models of components or subsystems are produced, which, if required, are put in concrete terms by means of inheritance mechanisms, for example if a great deal of detailed knowledge is available in the case of a certain model.

By comparing the actual behavior of a motor vehicle with the modeled behavior, model-based diagnostic algorithms are suited for the purpose of giving recommendations for suspicious components or also for additional measurement and test instructions.

Additional advantages and configurations of the invention result from the description and the accompanying drawing.

It goes without saying that the aforementioned characteristics and those yet to be explained are not only applicable in the combinations specified in each case but also in other combinations or by themselves without departing from the scope of the present invention.

### BRIEF DESCRIPTION OF THE DRAWINGS

FIG. 1 shows a schematic drawing in schematic depiction for a first known procedural approach from the technical field.

FIG. 2 shows a diagram in schematic depiction for a second known procedural approach from the technical field.

FIG. 3 shows a schematic diagram for a first embodiment of a method according to the invention.

FIG. 4 shows an embodiment in schematic depiction of a device according to the invention as well as a technical apparatus.

FIG. 5 shows a diagram in schematic depiction for a second embodiment of a method according to the invention.

### DETAILED DESCRIPTION

The method is schematically depicted in the diagram with the aid of examples of embodiment and is described in detail below while making reference to the drawing.

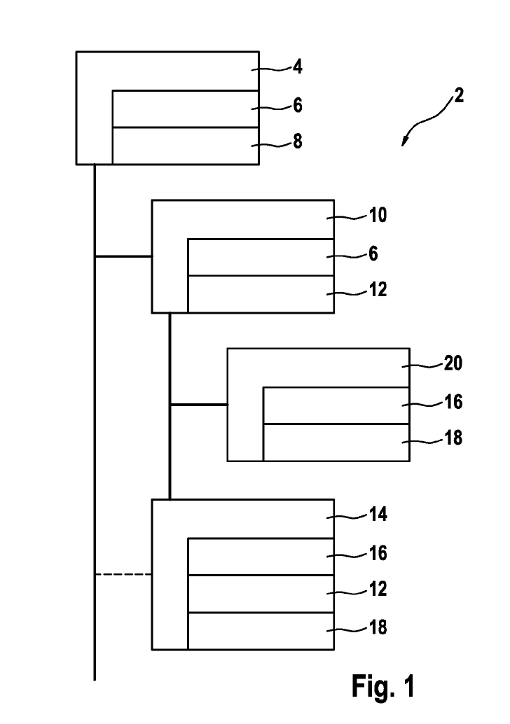

A diagram for a known procedural approach from the technical field is described with the aid of FIG. 1. Provision is made in an ignition system 2, which is schematically depicted by means of this diagram, for an ignition timer as a component of the ignition system 2 to serve here as a modeling example.

In so doing, a first version 4 of an ignition timer with two components is specified, namely contact breaker points 6 and an ignition capacitor 8. In addition a new second version 10 of the ignition timer is to be defined whereby techniques of the object oriented modeling are used. For this purpose, all components of the first version 4, which are not to change when used in the second version, are taken up without changes, for example the contact breaker points 6. Those components subject to change in the second version 10 are described in a different fashion. In this instance, the modified ignition capacitor 12 is affected.

Provision is made for an analogous approach for a third version 14 of the ignition timer. In this third version 14 of the ignition timer, modified contact breaker points 16, the modified ignition capacitor 12 as is known from the second version 10 as well as an additional component, a Hall sensor 18, are now present.

The modified contact breaker points 16 as well as the Hall sensor 18 as in the third version 14 are associated with a fourth intermediate version 20 of the ignition timer.

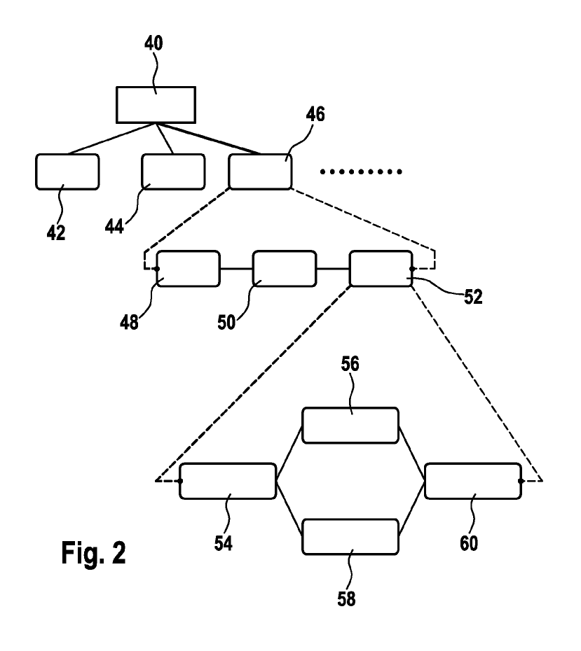

An additional object oriented approach, which is pursued when modeling the systems, is the hierarchical approach, i.e. components are logically assigned to subsystems and subsystems to systems or vice versa. A procedural approach known from the technical field is schematically described with the aid of the diagram from FIG. 2.

In schematic depiction, this diagram shows a hierarchical structure for a motor vehicle 40, which has three systems 42, 44, 46 in a first level. Provision is made in a second level for first subsystems 48, 50, 52, which are associated with a third system 46 of the first level. In a third level, components 54, 56, 58, 60 are associated with a third subsystem 52 of the second level.

Diagnostic algorithms according to the technical field work exclusively on the component level, i.e. each pathway of a system 42, 44, 46 must be traced back into the underlying subsystems 48, 50, 52 up until the level of the components 54, 56, 58, 60. Faults can only be detected there by concretely comparing the expected behavior of the components with the actual behavior. Within the scope of a diagnosis, a descent from a system into the component level thereby always occurs even if no fault is present. This, however, represents an enormous increase in computing time.

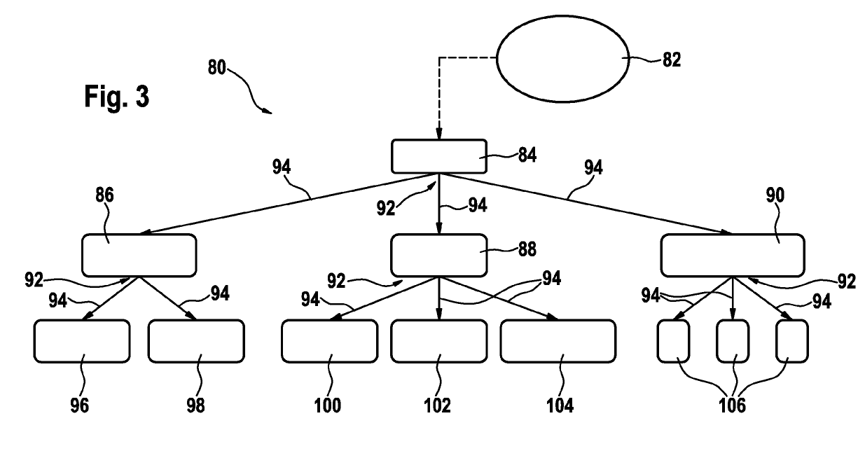

FIG. 3 shows a diagram in schematic depiction with a system graph 80, which is suited to execute a first embodiment of a method according to the invention.

With the aid of this system graph 80, a fault, which causes a symptom 82, namely “pinging and knocking”, is analyzed within the scope of a diagnosis of the technical apparatus, in this case a motor vehicle.

A first level (k=1) of the system graph 80 comprises a first node 84 of this first level. At the same time, an engine of the motor vehicle is associated with this first node 84 as a unit and consequently as a system.

A second level (k=2) of the system graph 80 comprises three nodes 86, 88, 90, wherein a subordinate unit, respectively a subordinate subsystem, is associated with these three nodes 86, 88, 90 of the second level, one of said nodes in each case being associated with the superior unit, respectively the superior node 84 of the first level. In so doing, a first subsystem of a first node 86 is configured as an ignition system, a second system of a second node 88 as an air system and a third subsystem of a third node 90 as an electric power supply system. This configuration of the system graph comprises only one second level for subsystems. As a rule, at least one second level for subsystems is provided. In this case, a second level with subsystems is associated with and hence subordinate to a first level with subsystems.

The node 84 of the first level additionally has a branch 92. Starting at said branch 92, the first node 84 is connected to three nodes 86, 88, 90 of the second level via three pathways 94.

Within a third level of the system graph 80, two subordinate nodes 96, 98 are associated with the first node 86 of the second level via pathways 94 starting at a branch 96 so that two units are associated with one unit of the technical apparatus, which in FIG. 3 is associated via the first node 86 of the second level. In so doing, a first node 96 as a subordinate component is associated with an ignition unit and a second node 98 as a spark plug associated with the ignition system is associated with said ignition unit.

Three units, respectively components, which are represented here by three nodes 100, 102, 104 are associated with the second component 88, the air system. A first node 100 thereby represents a turbocharger, a second node 102 an air cooler and a third node 104 an air temperature sensor. Provision is also made here for the second component of the second level to be connected to the components 100, 102, 104 of the third level, which are subordinate to the superior components 88 of the second level, via three pathways 94 starting at the junction 92.

The third node 90 of the second level, which represents the electric power supply system as a unit, respectively a system of the technical apparatus, is correspondingly connected to three nodes 106 of the third subordinate level starting from a branch 92 via three pathways 94. In this embodiment, the subordinate components and thereby the units are not further named.

Provision is made in this example of embodiment for the symptom 82 “pinging and knocking” to be observed. It is further assumed that the systems used are completely modeled. The observed symptom is an indication that a fault is present in the engine system. This can mean that the correct, expected behavior of the engine, which is represented by the node 84 of the first level, does not correlate with the actual behavior, namely “pinging and knocking”. Provision is therefore made for the engine system to be the starting point of the diagnosis and serves in this case as the system level and hence the first level. The engine system simply consists of the ignition, air and electric power supply systems, which form the subsystem levels and in this case the second level via the nodes 86, 88, 90.

As previously mentioned, the expected, correct behavior is deposited for each system and thus for each node 86, 88, 90 of the subsystems. The ignition system is initially examined and assessed to determine whether the correct, expected behavior correlates with the actual behavior. As a result, a descent into the underlying subsequent third levels with the nodes 96, 98 for the ignition system does not have to occur.

The examination of the air system subsequently occurs starting at the second node 88 of the second level. The expected, correct behavior does not include the observed symptom, whereby the system is seen as suspicious and the underlying and hence subsequent third level with the three nodes 100, 102, 104 is examined.

The electric power supply system at the third node 90 of the second level works on the other hand correctly, and analogous to the ignition system no further analysis of the underlying third levels and hence of the nodes 106 is necessary.

The next step now consists of examining the component levels and thus the third level for the air system. The turbocharger, the air cooler and the air temperature sensor are examined in order within the third level at the nodes 100, 102, 104. In so doing in this example, it is determined that the air cooler is the only component which does not exhibit correct, expected behavior. Thus, the air cooler has to be responsible for the observed symptoms.

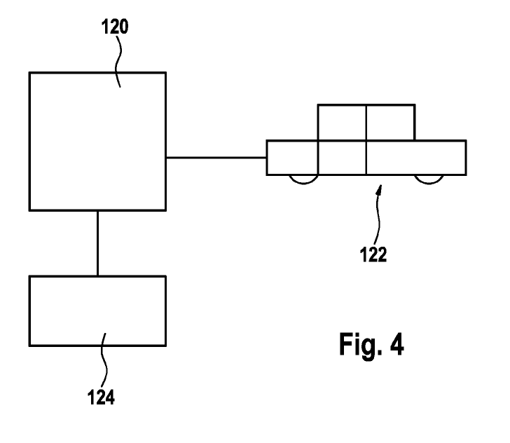

FIG. 4 shows in schematic depiction an embodiment of a device 120 according to the invention, which is configured for the purpose of describing a technical behavior of a technical apparatus, which is configured here as a motor vehicle 122, with the aid of a system graph 124, which the device 120 automatically generates within the scope of an embodiment of the method.

Provision is made for the motor vehicle 122 as a technical apparatus to have a number of units and for the automatically generated system graph 124 to comprise a number of levels. At this juncture, a k+1th level is in each case subordinate to a kth level, and at least one subordinate unit in the k+1th level is associated with a superior unit from the kth level.

Furthermore, a technical behavior of the at least one subordinate unit is summarized in each superior unit.

In order to acquire the behavior of the technical apparatus 122, the device 120 is connected to this technical apparatus 122. A description of the behavior of the technical apparatus 122 occurs via an automatically generated system graph 124. Provision is likewise made for a diagnosis to be performed by the device 120. In order to detect a fault, said device 120 is thereby configured to initially examine a kth level for a faulty unit within the system graph 124. When continuing the search for the fault in a k+1th level, only that at least one subordinate unit is examined, which is associated with a unit of the kth level that is identified as faulty.

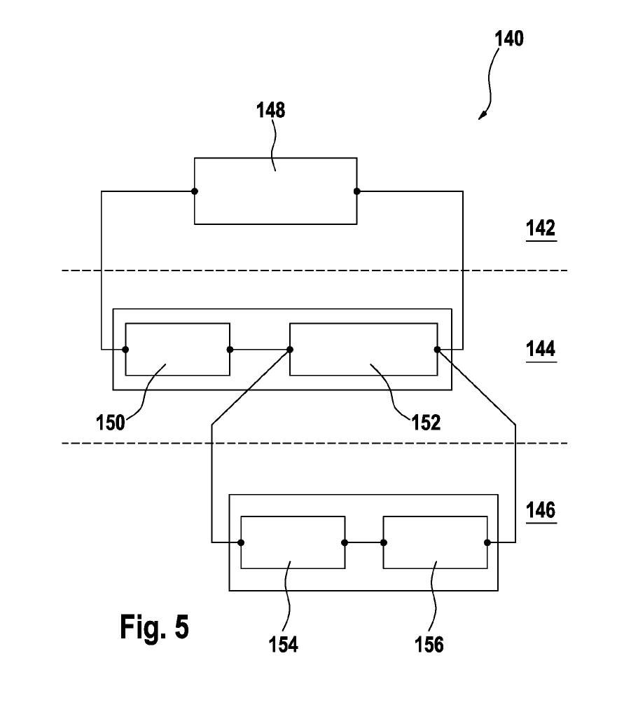

A detailed portion of a system graph 140, which is configured to carry out a second embodiment of the method according to the invention, is schematically depicted in FIG. 5.

This detailed portion of the system graph 140 thereby shows a first level 142, a second level 144 as well as a third level 146. Provision is made in this instance within the first level 142 for a first node 148 and hence for a first unit for a first subsystem. Within the second level 144, which can be considered to be an intermediate level in this instance, provision is made for a second node 150 and hence for a second unit for a first component as well as for a third node 152 and hence for a third unit for a second subsystem to complement the first node 148 of the first level 142. These two nodes 150, 152 of the second level 144 are associated with and hence subordinate to the first node 148 of the first level 142.

Provision is made within the third level 146 for a fourth node 154 for a fourth unit and thereby for a second component as well as for a fifth node 156 for a fifth unit and thereby for a third component. This fourth node 154 as well as this fifth node 156 and hence the second and the third component are subordinate to the second subsystem, which is associated with the third node 152 of the second level.

The embodiment presented with the aid of the system graph 140 therefore shows that a mixture of levels can also occur within the scope of the method. In the present case, this means that a subsystem associated with the third node 152 can exist here in the second level 144 next to a component associated with the second node 150.

When carrying out the method, the system graph 140 is automatically generated to describe a behavior of a technical apparatus, which hereby comprises in detail the first, second and third component as well as the first and the second subsystem. In this connection, the third level 146 is subordinate to the second level 144 as well as the first level 142. Furthermore, the second level 144 is subordinate to the first level 142. A technical behavior of the first component of the second node 150 and the first subsystem of the third node 152 is summarized in the first node 148 for the first subsystem. In addition because the technical behavior of the second and the third component, which are associated with the fourth and fifth node 154, 156 of the third level, continues to be summarized in the second subsystem of the third node 152, the behavior of the second and the third component is additionally summarized also in the first subsystem of the first node 148.

1. Method for describing a behavior of a technical apparatus, which has a number of units, wherein a system graph, which comprises a number of levels, is automatically generated for the technical apparatus, wherein a k+1th level is in each case subordinate to a kth level and at least one subordinate unit in the k+1th level is associated with a superior unit from the kth level, a technical behavior of the at least one subordinate unit being summarized in each superior unit.

2. Method according to claim 1, wherein the system graph has a tree-like structure, wherein each unit within the system graph is associated with a node so that a superior node of the kth level has at least one branch to at least one subordinate node of the k+1th level.

3. Method according to claim 2, wherein the behavior of the superior unit, which is associated with the superior node of the kth level, as well as the behavior of the at least one subordinate unit of the k+1th level, which is associated with the superior unit, is described via said superior node.

4. Method according to claim 1, wherein a behavior to be expected is deposited within the system graph for each unit.

5. Method for diagnosing a technical apparatus, which has a number of units, wherein a behavior of this technical apparatus is described by means of a method according to claim 1, in which
a kth level is initially examined for a faulty unit when searching for at least one fault, and in which
only that at least one subordinate unit is examined, which is associated with a unit of the kth level which is identified as faulty during a continuation of the search in a k+1th level.

6. Method according to claim 1, wherein a faultless behavior for every unit is deposited within the system graph.

7. Method according to claim 5, wherein each unit within the system graph is associated with a node, said nodes being connected to each other corresponding to a structure of the system graph via branches so that only branches with nodes, with which faulty units are associated, are analyzed when searching for the at least one fault.

8. Device, which is configured for the purpose of describing a behavior of a technical apparatus, which has a number of units, and thereby for automatically generating a system graph, which comprises a number of levels, for the technical apparatus and in so doing, said device is configured in each case for the purpose of placing a k+1th level subordinate to a kth level and for the purpose of associating at least one subordinate unit in the k+1th level with a superior unit from the kth level and thereby for summarizing a technical behavior of the at least one subordinate unit in each superior unit.

9. Device according to claim 8, which is configured for the purpose of searching for at least one fault within the technical apparatus and in so doing for initially examining the kth level for a faulty unit within the technical apparatus. When continuing the search in the k+1th level, said device is configured for the purpose of examining only that at least one subordinate unit, which is associated with a unit of the kth level that is identified as faulty.

10. Computer program with program code means for carrying out all of the steps of a method according to claim 1 if the computer program is executed on a computer or in a corresponding processing unit.

11. Computer program product with program code means, which are stored on a machine-readable data carrier, for carrying out all of the steps of a method according to claim 1 if the computer program is executed on a computer or in a corresponding processing unit.
